(19) United States
(12) Patent Application Publication
(10) Pub. No.: US 2009/0106322 A1
(43) Pub. Date: Apr. 23, 2009

(54) TWO-SET METHOD FOR AVOIDING DATA LOSS WHEN MULTIPLE USERS SIMULTANEOUSLY EDIT THE SAME DATA

(76) Inventor: Jen-Yeu T. Chen, Cedar Park, TX (US)

Correspondence Address: IBM CORP (YA);C/O YEE & ASSOCIATES PC, P.O. BOX 802333, DALLAS, TX, 75380, US

(21) Appl. No.: 11/874,229

(22) Filed: Oct. 18, 2007

(51) Int. Cl. G06F 17/30

(52) U.S. Cl. 707/201; 707/E17.007

(57) ABSTRACT

A method is provided for modifying data in a database, wherein multiple users are each authorized to modify the data at the same time. The method comprises the steps of accessing a specified data set contained in the database, wherein the data set comprises multiple data elements, and forming first and second data sets that are initially both identical to the specified data set. At least some of the data elements of the first data set are selectively modified, while the second data set is kept or retained in an unchanged condition. The first and second data sets are then compared with one another in order to identify each of the modified data elements of the first data set, wherein each modified data elements corresponds to a data element of the specified data set in the database. Each modified data element is written to the specified data set contained in the database, wherein each modified data element replaces its corresponding data element. However, other data elements of the specified data set are not replaced by contents of the first data set.

### BACKGROUND OF THE INVENTION

1. Field of the Invention

The invention disclosed and claimed herein generally pertains to a method for preventing data from being lost or overwritten, when multiple authorized users edit the same data at the same time. More particularly, the invention pertains to a method of the above type wherein a two-set approach is used to avoid data loss, whenever a set of data from the database is accessed for editing. Even more particularly, the invention pertains to a two-set method of the above type wherein each authorized user can load the data onto a web page in order to modify the data.

2. Description of the Related Art

Very frequently, multiple administrators or other users are all authorized to access the same data, and are further authorized to edit or modify the data. In a common arrangement, each authorized user may access a website, whereupon the data is automatically loaded from a database onto a web page. The user may then work with the data, and change it or modify it as necessary. This arrangement could be used, for example, when software is being developed by a group comprising two or more members, including members that are located remotely from one another. Alternatively, the authorized users may have nothing to do with software development, but can modify a database through the provided web site. Generally, the most recently modified data is regarded as the most correct and accurate version thereof.

Typically, in arrangements of the above type a user will load a set of data from the database onto a web page, wherein the data set comprises a number of discrete data elements. The user then proceeds to modify some or all of the data elements in the set. At the end of his web session, he will write the data set from the web page back into the database. In accordance with a currently used write back procedure, each modified data element will replace the data element, in the original data set contained in the database, that corresponds to the modified data element. Also, each unmodified data element from the web page will replace its corresponding data element in the original data set in the database.

In the above currently used procedure, if the unmodified data elements from the web page are identical to the respective corresponding data elements they replace in the database, no problem will generally arise. However, it could happen, for example, that a first user accesses the original data set from the database, loads it to a web page, and modifies particular original data elements of the data set. While the first user is engaged in this effort, a second user also accesses the original data set from the database, and also modifies some of the original data elements, but does not modify the particular elements from their original forms. Then, if the first user writes his data set back to the database before the second user does so, the modified particular data elements will replace those elements in their respective original forms in the database. Thereafter, however, the second user will write his modified data set back to the database. When this happens, the unmodified data elements of the second user, that correspond to the particular data elements, will respectively replace the modified particular data elements in the database. The unmodified replacement elements, from the data set of the second user, are identical to the original particular data elements. Thus, the modifications made to the particular data elements by the first user are overwritten and lost.

It would be advantageous to provide a method or procedure for avoiding this type of data loss, wherein the procedure minimized the hardware and software resources needed therefor, and also minimized complexity.

### SUMMARY OF THE INVENTION

A method is provided for modifying data in a database, wherein multiple users are each authorized to modify the data at the same time. The method comprises the steps of accessing a specified data set contained in the database, wherein the data set comprises multiple data elements, and forming first and second data sets that are initially both identical to the specified data set. At least some of the data elements of the first data set are selectively modified, while the second data set is kept or retained in an unchanged condition. The first and second data sets are then compared with one another in order to identify each of the modified data elements of the first data set, wherein each modified data element corresponds to a data element of the specified data set in the database. Each modified data element is written to the specified data set contained in the database, wherein each modified data element replaces its corresponding data element in the specified data set. However, other data elements of the specified data set are not replaced by any data elements of the first data set.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram showing a network of data processing systems that may be used in implementing embodiments of the invention.

FIG. 2 is a block diagram showing a computer or data processing system that may be used in implementing embodiments of the invention.

FIG. 3 is a schematic diagram for illustrating concepts and principles of embodiments of the invention.

FIG. 4 is a flowchart that depicts principal steps for an embodiment of the invention.

### DETAILED DESCRIPTION OF THE PREFERRED EMBODIMENT

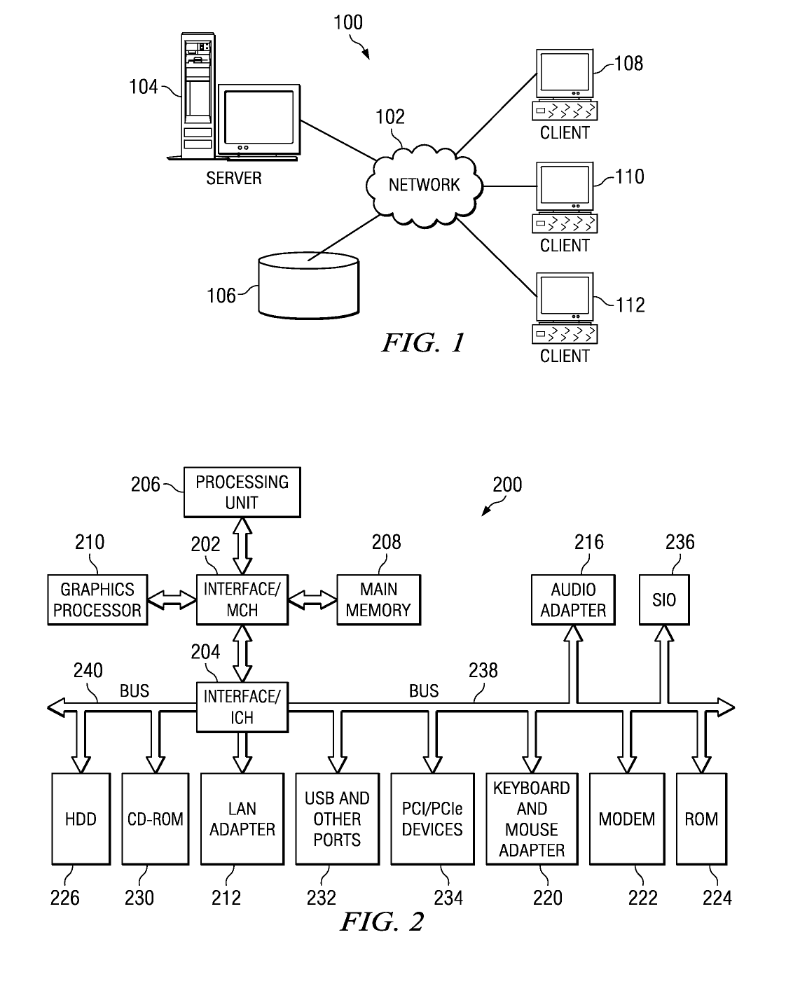

FIGS. 1 and 2 are provided as exemplary diagrams of data processing environments in which embodiments of the present invention may be implemented.

FIGS. 1 and 2 are only examples, and are not intended to limit embodiments of the invention in any way. Many modifications to the depicted environments may be made without departing from the spirit and scope of the present invention.

Referring to FIG. 1, there is shown a pictorial representation of a network of computers or data processing systems in which embodiments of the present invention may be implemented. A configuration of linked or networked data processing systems 100 contains a network 102, which is the medium used to provide communication links between various devices and computers connected together within configuration 100. Network 102 may include connections, such as wire, wireless communication links, or fiber optic cables. In the depicted example, server 104 connects to network 102 along with storage unit 108. In addition, clients 108, 110, and 112 connect to network 102.

Server 104 may be used to provide a website associated with a database 106 that contains specified data, wherein the specified data can be edited or modified by multiple authorized administrators or users. Each of the clients 108-112 is an exemplary computer or other work station, which can be operated by one of the authorized users to access the specified data from the database. Accessed data can be automatically loaded onto a web page at the website and displayed to a user. The user may then operate his workstation to edit the data and write the edited data back to the database, in accordance with an embodiment of the invention. Embodiments can be implemented by means of hardware and software components located at the server 104 and/or clients 108-112. Network configuration 100 may, of course, include additional servers, clients, and other devices not shown.

In the depicted example, network configuration 100 is the Internet, with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network configuration 100 also may be implemented as a number of different types of networks, such as for example, an intranet, a local area network (LAN), or a wide area network (WAN). FIG. 1 is intended as an example, and not as an architectural limitation for different embodiments of the present invention.

Referring to FIG. 2, there is shown a data processing system 200 that may be used in implementing embodiments of the invention. Data processing system 200 is an example of a computer, such as server 104 or client 108 in FIG. 1, in which computer usable code or instructions implementing the processes for embodiments of the present invention may be located. Data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In data processing system 200, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1 and 2 may vary depending on the implementation. Also, the processes of the present invention may be applied to a multiprocessor data processing system.

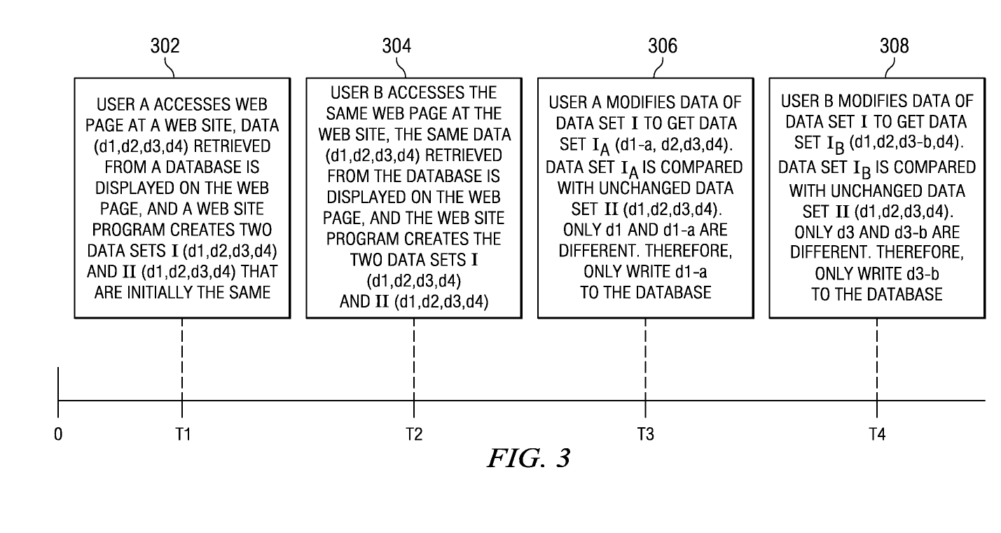

Referring to FIG. 3, there is shown a schematic diagram comprising a chart that extends along a timeline, in order to illustrate basic principles of an embodiment of the invention. More particularly, FIG. 3 shows sets of events 302-308, which occur in sequence at times T1-T4, respectively.

At time T1, a user A retrieves a data set from a location in database 106 or the like, wherein the data set comprises discrete data elements (d1,d2,d3,d4). In accordance with the embodiment of the invention, two data sets I and II are formed or created from the retrieved data. Thus, data set I and data set II each comprises the data elements (d1,d2,d3,d4), so that initially the two data sets are identical. When a user accesses a web site, data retrieved from a database and displayed on the web page are saved into two data sets. More particularly the web program associated with the web site creates data sets which may be variable arrays (or may be discrete variables or any other form), wherein each variable array saves one set of the retrieved data. After the user modifies data on the web page, he clicks the submit button on the web page. The program will process to modify the data in the first data set (or first variable array), based on the data displayed on the web page, and then the program will compare the first data set (first variable array) with the second data set (second variable array), which is unchanged. The second data set thus serves as a reference. User A may operate a client such as client 108, in order to carry out the events of set 302 at time T1. Also, it is to be understood that user A is one of multiple administrators, who are each authorized to simultaneously edit or modify data that was retrieved from the database.

At time T2, in connection with events at 304, a user B retrieves the data set from the same database location that was accessed by user A. Moreover, the time period between T1 and T2 is quite short, so that the data set at the database location is not changed during such time period. Accordingly, the data set retrieved by user B likewise comprises the data elements (d1,d2,d3,d4). Also at time T2, the two data sets I and II are again created, each initially comprising the elements (d1,d2,d3,d4). Data set I is loaded onto a web page of the website, and is displayed on the web page to user B. Data set II is stored so that it will remain unchanged. User B operates a client such as client 110 in order to carry out the events of set 304, at time T2. Users A and B may be remotely located from one another, and user B, in like manner with user A, is one of multiple administrators authorized to edit data that is retrieved from the database.

At time T3, in connection with event set 306, user A modifies data set I to produce a data set I_{A} (d1-a,d2,d3,d4). The data set I_{A} is then compared with the unchanged reference data set II, in order to identify any elements of data set I_{A} that were modified by user A from the retrieved data set I. Usefully, the comparison procedure is carried out by comparing each data element of data set I_{A} with the corresponding data element of set II. Each element in set I_{A} that is found to be different from its corresponding data set II element is considered to be a modified data element. In the event set 306, only the data element corresponding to d1 was modified in set I_{A}, to d1-a. Accordingly, only d1-a is written to the data set at the database location, in order to replace the corresponding data element d1 and to update such element to d1-a. It is to be emphasized that no other change is made to the data set in the database, as the result of the events of event set 306.

At time T4, user B modifies data set I to produce a data set I_{B} (d1,d2,d3-b,d4). The data set I_{B} is then compared with the unchanged reference data set II, in order to identify any elements of data set I_{B} that were modified from the retrieved data set. In event set 308, only the data element corresponding to d3 was modified in I_{B}, to d3-b. Thus, only d3-b is written to the data set at the database location, to replace the corresponding data element d3 and update such element position to d3-b. No other change is made to the data set in the database, as a result of events of event set 308. It is anticipated that an algorithm could be readily constructed to carry out the comparing and data writing tasks described above in connection with the events of event sets 306 and 308.

By following the procedure disclosed in FIG. 3, the data set in the database becomes (d1-a,d2,d3-b,d4), after the sessions of users A and B have both ended following time T4. This is clearly correct, since the data set includes all of the modifications made by both user A and user B that were not changed by later modifications. The same result would have been achieved if user B had ended his session before user A.

On the other hand, if a prior art procedure had been used instead of the embodiment of the invention, data set I_{A}, in its entirety, would have been used at T3 to update the data set in the database. Thus, the data in the database would have become (d1-a,d2,d3,d4). Then, at time T4 the entire data set I_{B} would have been written to the data set in the database. This would have made the final data set to be (d1,d2,d3-b,d4). This is clearly incorrect, since in this set the data element d1-a, the modification of user A, has been lost.

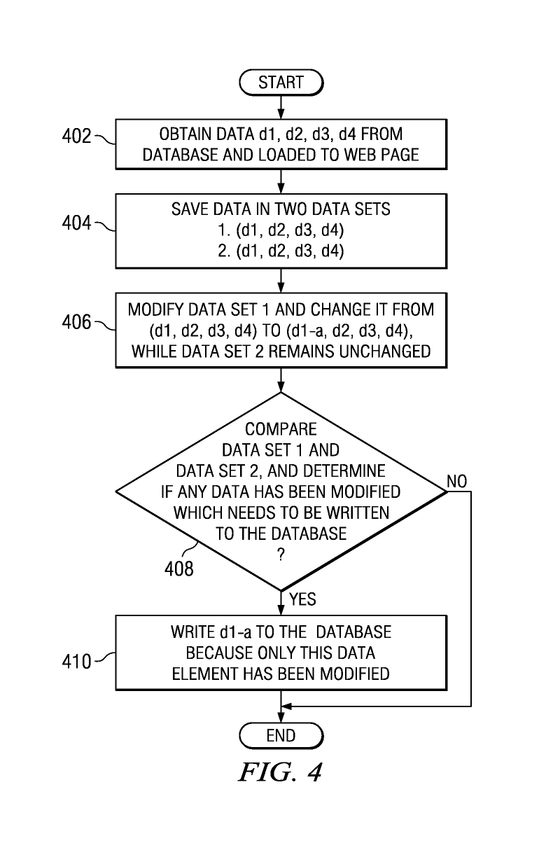

Referring to FIG. 4, there is shown a flowchart summarizing principal steps for a method comprising an embodiment of the invention. The method of FIG. 4 can be carried out by each of multiple users, wherein each user is authorized to access and modify specified data at the same time. At step 402, a data set comprising the elements (d1,d2,d3,d4) is obtained from a database and loaded to a web page. At step 404, this data is saved or formed into two initially identical data sets, data set 1 and data set 2.

Referring further to FIG. 4, step 406 shows that data set 1 is modified, for example, to change the data set to (d1-a,d2,d3,d4). As described above, after data has been loaded on a web page from the database, the data shown on the web page are saved into two data sets 1 and 2. Data set 1 will be modified after the user has made modifications and then submits the modified web page. Step 406 further shows that data set 2 remains unchanged, while data set 1 is being modified. At step 408, data sets 1 and 2 are compared, such as by using procedures described above. If the comparison indicates that there has been no modification made to data set 1 that must be written to the database, the method of FIG. 4 ends. Otherwise, each modified data elements of data set 1 must be written to update the data set in the database, as shown at step 410.

While the method of FIG. 4 shows only data element d1 of data set being modified to d1-a, in general such method can be used to modify either single or multiple data elements, during any given web session. Moreover, it is anticipated that if multiple users are all authorized to modify the same data, and if each of them adheres to the method of FIG. 4 when making data modifications, loss of data as described above would be avoided.

The invention can take the form of an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk—read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for modifying data in a database, wherein multiple users are each authorized to modify the data at the same time, and said method comprises the steps of:
accessing a specified data set contained in said database, wherein said data set comprises multiple data elements;
forming first and second data sets that are initially both identical to said specified data set in said database;
selectively modifying at least some of the data elements of said first data set, while retaining said second data set in an unchanged condition;
comparing said first and second data sets in order to identify each of said modified data elements of said first data set, wherein each modified data element corresponds to a data element of said specified data set contained in said database; and
writing each modified data element to said specified data set contained in said database, wherein each modified data element replaces its corresponding data element in said specified data set, and other data elements of said specified data set are not replaced by any data element of said first data set.

2. The method of claim 1, wherein:
said comparing step comprises comparing each data element of said first data set with a corresponding data element of said second data set, in order to identify the respective data elements of said first data set that have been modified.

3. The method of claim 1, wherein:
a user accesses a web page loaded with said first data set to selectively modify data elements of said first data set, said user then submits said web page, and thereafter a web program carries out said comparing step to identify each of said modified data elements of said first data set, and writes said modified first data elements to update said database.

4. The method of claim 1, wherein:
first and second users are each disposed to modify data elements of said specified data set, during the same period of time, by each performing respective steps of said method.

5. The method of claim 4, wherein:
said first user performs said writing step before said second user performs said writing step, and said second user has not modified one or more data elements of said specified data set that were modified by said first user.

6. The method of claim 5, wherein:
said first and second users are remotely located from one another.

7. The method of claim 1, wherein:
when a specified web site is accessed, a data set identical to said specified data set is retrieved from said database and loaded to a web page, and a program of said specified web site saves said retrieved data to said first and second data sets, wherein said first and second data sets are created to each have a form selected from a set of form types, said set of form types including at least variable arrays and discrete variables.

8. The method of claim 7, wherein:
said second data set is stored in a memory, and said comparing step is carried out by a specified algorithm.

9. A computer program product embedded in a computer readable medium for modifying data in a database, wherein multiple users are each authorized to modify the data at the same time, and said computer program product comprises:
first instructions for accessing a specified data set contained in said database, wherein said data set comprises multiple data elements;
second instructions for forming first and second data sets that are initially both identical to said specified data set in said database;
third instructions for selectively modifying at least some of the data elements of said first data set, while retaining said second data set in an unchanged condition;
fourth instructions for comparing said first and second data sets in order to identify each of said modified data elements of said first data set, wherein each modified data element corresponds to a data element of said specified data set contained in said database; and
fifth instructions for writing each modified data element to said specified data set contained in said database, wherein each modified data element replaces its corresponding data element in said specified data set, and other data elements of said specified data set are not replaced by any data element of said first data set.

10. The computer program product of claim 9, wherein:
each data element of said first data set is compared with a corresponding data element of said second data set, in order to identify the respective data elements of said first data set that have been modified.

11. The computer program product of claim 9, wherein:
a data set identical to said specified data set is retrieved from said database and placed onto a web page, a web program saves said retrieved data set in said first and second data sets, and said first data set represents the data on the web page when a user submits the web page to write said modified data elements to said specified data set in said database.

12. The computer program product of claim 9, wherein:
first and second users are each disposed to modify data elements of said specified data set, during the same period of time.

13. The computer program product of claim 12, wherein:
said first user implements said fifth instructions to perform said writing task before said second user performs said writing task, and said second user has not modified one or more data elements of said specified data set that were modified by said first user.

14. The computer program product of claim 13, wherein:
said first and second users are remotely located from one another.

15. Apparatus for modifying data in a database, wherein multiple users are each authorized to modify the data at the same time, and said apparatus comprises:
a first component for accessing a specified data set contained in said database, wherein said data set comprises multiple data elements;
a second component for forming first and second data sets that are initially both identical to said specified data set in said database;
a third component for selectively modifying at least some of the data elements of said first data set, while retaining said second data set in an unchanged condition;
a fourth component for comparing said first and second data sets in order to identify each of said modified data elements of said first data set, wherein each modified data element corresponds to a data element of said specified data set contained in said database; and
a fifth component for writing each modified data element to said specified data set contained in said database, wherein each modified data element replaces its corresponding data element in said specified data set, and other data elements of said specified data set are not replaced by any data element of said first data set.

16. The apparatus of claim 15, wherein:
said fourth component is operated to compare each data element of said first data set with a corresponding data element of said second data set, in order to identify the respective data elements of said first data set that have been modified.

17. The apparatus of claim 15, wherein:
a data set identical to said specified data set is retrieved from said database and placed onto a web page, a web program saves said retrieved data set in said first and second data sets, and said first data set represents the data on the web page when a user submits the web page to write said modified data elements to said specified data set in said database.

18. The apparatus of claim 15, wherein:
first and second users are each disposed to modify data elements of said specified data set, during the same period of time.

19. The apparatus of claim 15, wherein:
when a specified web site is accessed, a data set identical to said specified data set is retrieved from said database and loaded to a web page, and a program of said specified web site saves said retrieved data to said first and second data sets, wherein said first and second data sets are created to each have a form selected from a set of form types, said set of form types including at least variable arrays and discrete variables.

20. The apparatus of claim 19, wherein:
said second data set is stored in a memory, and said comparing step is carried out by a specified algorithm.
